(19) United States
(12) Patent Application Publication
(10) Pub. No.: US 2026/0184381 A1
(43) Pub. Date: Jul. 2, 2026

(54) VEHICLE BODY STRUCTURE

(71) Applicant: SUBARU CORPORATION, Tokyo (JP)

(72) Inventor: Hiroyuki KATSUYAMA, Tokyo (JP)

(21) Appl. No.: 19/410,575

(22) Filed: Dec. 5, 2025

(30) Foreign Application Priority Data
Dec. 27, 2024 (JP) 2024-231807

(51) Int. Cl. B62D 25/20; B62D 43/10

(52) U.S. Cl. CPC B62D 25/20; B62D 43/10

(57) ABSTRACT

A vehicle body structure includes a rear floor panel having a right-rear frame and a left-rear frame each extending in a longitudinal direction of a vehicle body, and a recess formed between the right-rear frame and the left-rear frame. The vehicle body structure further includes a die-cast structure joined to the rear floor panel. The rear floor panel includes a first frame joined to the right-rear frame, and a second frame joined to the left-rear frame. The die-cast structure further includes a curved wall that is continuous with the recess of the rear floor panel, a first rib that joins the curved wall and the first frame, and a second rib that joins the curved wall and the second frame.

### CROSS-REFERENCE TO RELATED APPLICATIONS

The present application claims priority from Japanese Patent Application No. 2024-231807 filed on December 27, 2024, the entire contents of which are hereby incorporated by reference.

### BACKGROUND

The disclosure relates to a vehicle body structure. A vehicle such as an automobile comprises an underbody constituted by a center floor, a rear floor, and the like (see Japanese Unexamined Patent Application Publication (JP-A) Nos. 2013-35395, 2022-117760, and 2021-17123). The center floor and rear floor are provided with side members extending in a longitudinal direction of the vehicle body.

### SUMMARY

An aspect of the disclosure provides a vehicle body structure comprising a rear floor panel. The rear floor panel comprises a right-rear frame and a left-rear frame each extending in a longitudinal direction of a vehicle body, and has a recess formed between the right-rear frame and the left-rear frame. The vehicle body structure further comprises a die-cast structure joined to the rear floor panel. The die-cast structure comprises a first frame joined to the right-rear frame, and a second frame joined to the left-rear frame. The die-cast structure comprises a curved wall that is continuous with the recess of the rear floor panel, a first rib that joins the curved wall and the first frame, and a second rib that joins the curved wall and the second frame.

### BRIEF DESCRIPTION OF THE DRAWINGS

FIG. 1 is a diagram illustrating a vehicle comprising a vehicle body structure according to an embodiment of the disclosure.

FIG. 2 is a diagram illustrating a portion of an underbody viewed from a direction of arrow II in FIG. 1.

FIG. 3 is a perspective view of a portion of the underbody viewed from a direction of arrow III in FIG. 1.

FIG. 4 is a diagram illustrating a die-cast structure of a rear floor.

FIG. 5 is a cross-sectional view of a die-cast structure taken along line V-V in FIG. 2.

FIG. 6 is an end view of the underbody taken along line VI-VI in FIG. 2.

FIG. 7 is a diagram illustrating an example of a collision load being transmitted during a rear-end collision.

FIG. 8 is a diagram illustrating an example of a collision load being transmitted during a rear-end collision.

FIG. 9 is a cross-sectional view of another example of a die-cast structure.

FIG. 10 is a diagram illustrating another vehicle to which the technique of the disclosure is applied.

### DETAILED DESCRIPTION

In rear-end collisions such as those caused by another vehicle, it is common practice to allow side members of a rear floor to deform so as to absorb energy to protect a passenger compartment, or cabin, from deformation. In addition, since the rear floor is provided with components such as a fuel tank and high-voltage cables, a configuration is provided to suppress deformation of the rear floor during a rear-end collision in addition to protecting the cabin.

Hereinafter, an embodiment of the disclosure will be described in detail with reference to the drawings. In the following descriptions, the same or substantially same components and elements are denoted by the same reference signs and repetitive descriptions are omitted.

### Underbody

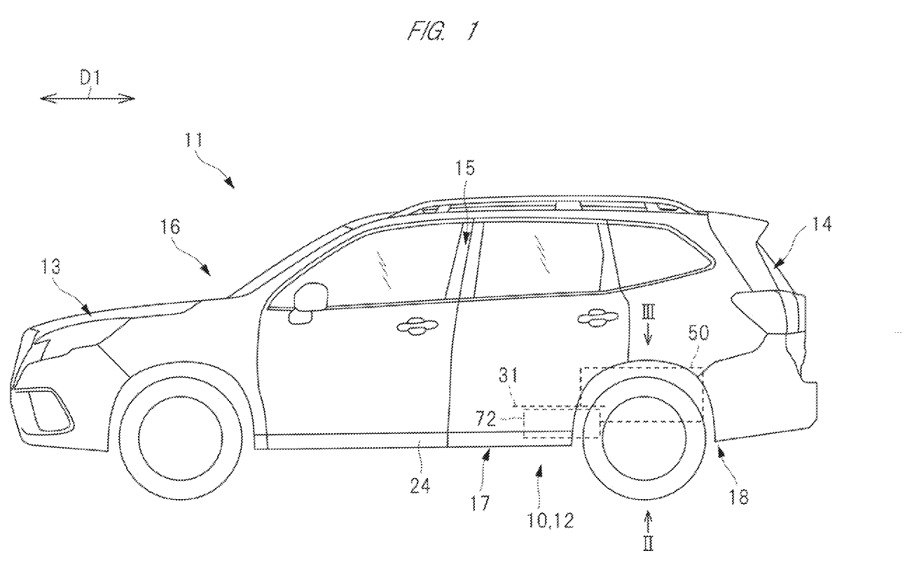

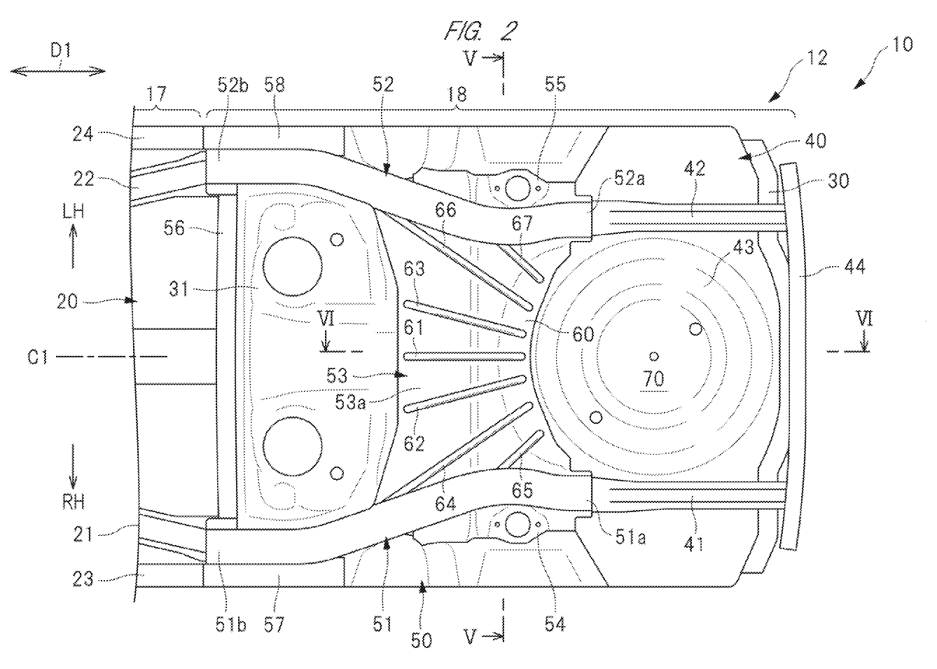

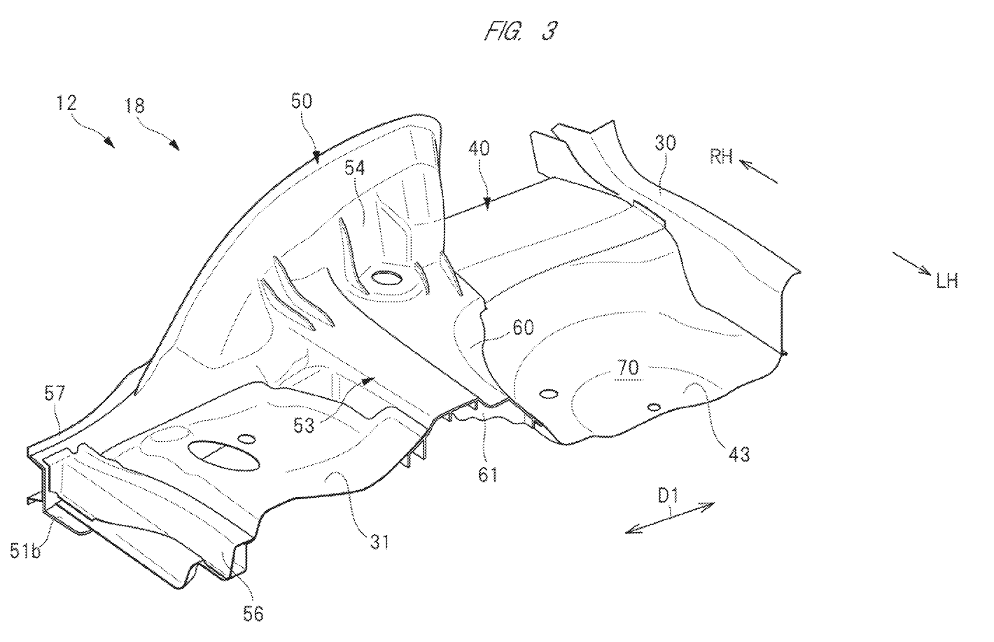

FIG. 1 is a diagram illustrating a vehicle 11 comprising a vehicle body structure 10 according to an embodiment of the disclosure. FIG. 2 is a diagram illustrating a portion of an underbody 12 viewed from a direction of arrow II in FIG. 1, that is, from a lower surface side. FIG. 3 is a perspective view of a portion of the underbody 12 viewed from a direction of arrow III in FIG. 1, that is, from an upper surface side. FIG. 3 illustrates a right-rear portion of the underbody 12 cut approximately at a center in a vehicle width direction of the vehicle.

As illustrated in FIG. 1, the vehicle 11 comprises a vehicle body 16 constituted by the underbody 12, a front body 13, a rear body 14, side bodies 15, and the like. As illustrated in FIG. 2, the underbody 12 comprises a center floor 17 forming a center portion of the vehicle body, and a rear floor 18 forming a rear portion of the vehicle body. The center floor 17 and the rear floor 18 are joined to each other using an adhesive, fasteners, spot welding, or the like.

The center floor 17 is formed by a center floor panel 20 which is a sheet metal part. The center floor panel 20 comprises a right-center side member (right-center frame) 21 and a left-center side member (left-center frame) 22 each extending in a longitudinal direction D1 of the vehicle body 16. The right-center side member 21 is disposed on a right-hand side RH relative to a center C1 in the vehicle width direction, and the left-center side member 22 is disposed on a left-hand side LH relative to the center C1 in the vehicle width direction. In addition, a right-hand portion of the center floor panel 20 is provided with a right-side side sill 23 extending in the longitudinal direction D1 of the vehicle body 16, and a left-hand portion of the center floor panel 20 is provided with a left-side side sill 24 extending in the longitudinal direction D1 of the vehicle body 16.

As illustrated in FIGS. 2 and 3, the rear floor 18 is formed by a rear floor panel 40, a lower back panel 30, and a tank floor panel 31 which are sheet metal parts, and a die-cast structure 50 which is a cast part. As illustrated in FIG. 2, the rear floor panel 40 comprises a right-rear side member (right-rear frame) 41 and a left-rear side member (left-rear frame) 42 each extending in the longitudinal direction of the vehicle body 16. The right-rear side member 41 is disposed on the right-hand side RH relative to the center C1 in the vehicle width direction, and the left-rear side member 42 is disposed on the left-hand side relative to the center C1 in the vehicle width direction. In addition, the rear floor panel 40 has a substantially circular recess 43 formed between the right-rear side member 41 and the left-rear side member 42. Further, a rear bumper beam 44 is joined to rear ends of the right-rear side member 41 and the left-rear side member 42. Note that a rear end of the rear floor panel 40 is joined to the lower back panel 30.

### Die-Cast Structure

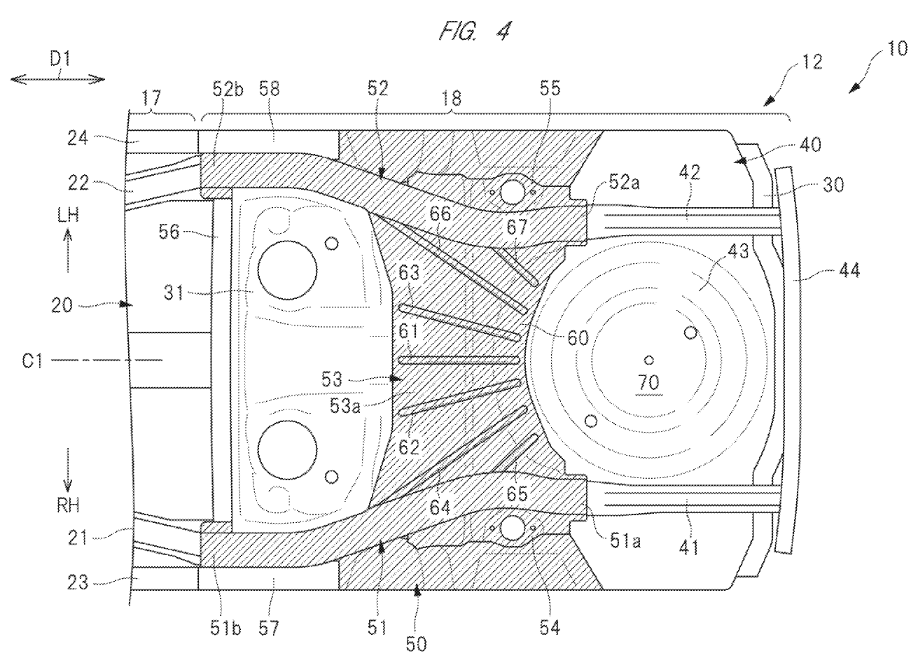

FIG. 4 is a diagram illustrating the die-cast structure 50 of the rear floor 18. FIG. 4 illustrates the die-cast structure 50 with hatched lines and illustrates the same parts as in FIG. 2. As illustrated in FIGS. 2 and 4, the rear floor panel 40 and the center floor panel 20 are joined to each other via the die-cast structure 50. That is, the die-cast structure 50 is joined to the rear floor panel 40, and the center floor panel 20 is joined to the die-cast structure 50. Note that the die-cast structure 50 and each of the various floor panels 20, 31, and 40 are joined to each other using an adhesive, fasteners, welding, or the like. The die-cast structure 50 and each of the various floor panels 20, 31, and 40 may be joined to each other using any one of an adhesive, fasteners, and welding, or may be joined to each other using two or more of an adhesive, fasteners, and welding in combination. In addition, aluminum alloy is used as a material for the die-cast structure 50 which is a die-cast part.

As illustrated in FIGS. 2 to 4, the die-cast structure 50 comprises a first frame 51 and a second frame 52 each extending in the longitudinal direction D1 of the vehicle body 16. The first frame 51 is disposed on the right-hand side RH relative to the center C1 in the vehicle width direction, and the second frame 52 is disposed on the left-hand side relative to the center C1 in the vehicle width direction. In addition, the die-cast structure 50 comprises a floor body 53 provided at the center C1 in the vehicle width direction so as to join the first frame 51 and the second frame 52 to each other. Further, the die-cast structure 50 comprises a suspension tower 54 that is continuous with the right-hand portion of the first frame 51, and a suspension tower 55 that is continuous with the left-hand portion of the second frame 52.

As illustrated in FIGS. 2 and 4, the right-rear side member 41 and the right-center side member 21 are joined to each other via the first frame 51 of the die-cast structure 50. That is, a rear end 51a of the first frame 51 is joined to the right-rear side member 41 of the rear floor panel 40, and a front end 51b of the first frame 51 is joined to the right-center side member 21 of the center floor panel 20. Similarly, the left-rear side member 42 and the left-center side member 22 are joined to each other via the second frame 52 of the die-cast structure 50. That is, a rear end 52a of the second frame 52 is joined to the left-rear side member 42 of the rear floor panel 40, and a front end 52b of the second frame 52 is joined to the left-center side member 22 of the center floor panel 20.

The front ends 51b and 52b of the first frame 51 and the second frame 52 are joined to each other via a cross member 56. In addition, the tank floor panel 31 is disposed between the first frame 51 and the second frame 52 that are projecting from the floor body 53. The tank floor panel 31 is joined to the first frame 51, the second frame 52, the floor body 53, and the cross member 56. Further, the right-side side sill 23 of the center floor panel 20 is joined to the first frame 51 and the suspension tower 54 via a joining frame 57. Similarly, the left-side side sill 24 of the center floor panel 20 is joined to the second frame 52 and the suspension tower 55 via a joining frame 58.

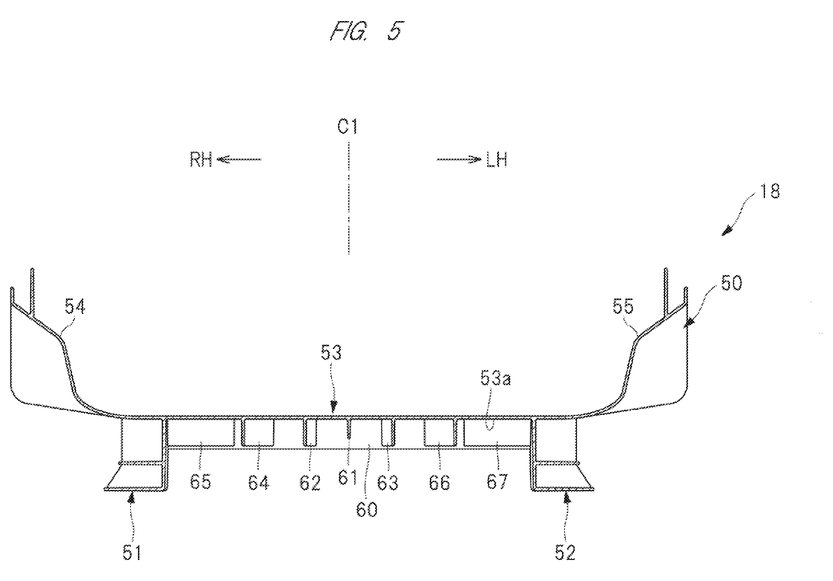

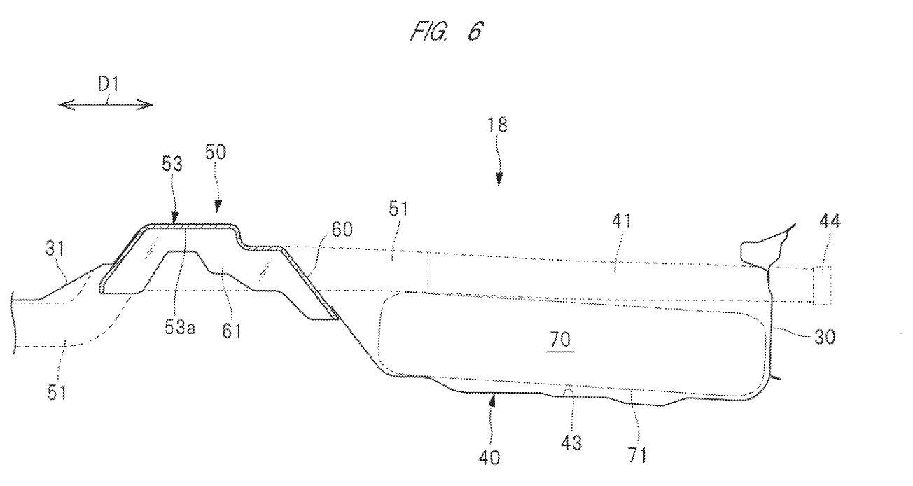

FIG. 5 is a cross-sectional view of the die-cast structure 50 taken along line V-V in FIG. 2, and FIG. 6 is an end view of the underbody 12 taken along line VI-VI in FIG. 2. As illustrated in FIGS. 2 and 3, the die-cast structure 50 joined to the rear floor panel 40 has a curved wall 60 that is continuous with the recess 43 of the rear floor panel 40. In addition, as illustrated in FIGS. 2, 5, and 6, a lower surface 53a of the floor body 53 of the die-cast structure 50 is provided with multiple ribs 61 to 67 each extending radially outward from the curved wall 60.

That is, the die-cast structure 50 comprises the ribs 61, 62, and 63 each extending from the curved wall 60 toward the tank floor panel 31, the ribs (first rib) 64 and 65 each extending from the curved wall 60 toward the first frame 51, and the ribs (second rib) 66 and 67 each extending from the curved wall 60 toward the second frame 52. In other words, the die-cast structure 50 comprises the ribs 64 and 65 that join the curved wall 60 and the first frame 51, and the ribs 66 and 67 that join the curved wall 60 and the second frame 52. In addition, the ribs 64 and 65 are inclined relative to the longitudinal direction D1 of the vehicle body 16, and the ribs 66 and 67 are inclined relative to the longitudinal direction D1 of the vehicle body 16. That is, the ribs 64 to 67 are inclined laterally in the vehicle width direction relative to the longitudinal direction D1 of the vehicle body 16.

As illustrated in FIGS. 3 and 6, a housing 70 is formed in the rear floor 18 by the recess 43 of the rear floor panel 40, the curved wall 60 of the die-cast structure 50, and the lower back panel 30. That is, the housing 70 is formed in the rear floor 18 by the recess 43 of the rear floor panel 40 and the curved wall 60 of the die-cast structure 50. In addition, as illustrated in FIG. 6, the housing 70 in the rear floor 18 accommodates a spare tire 71 which is a replacement tire for the vehicle.

### Load Transmission During a Rear-End Collision

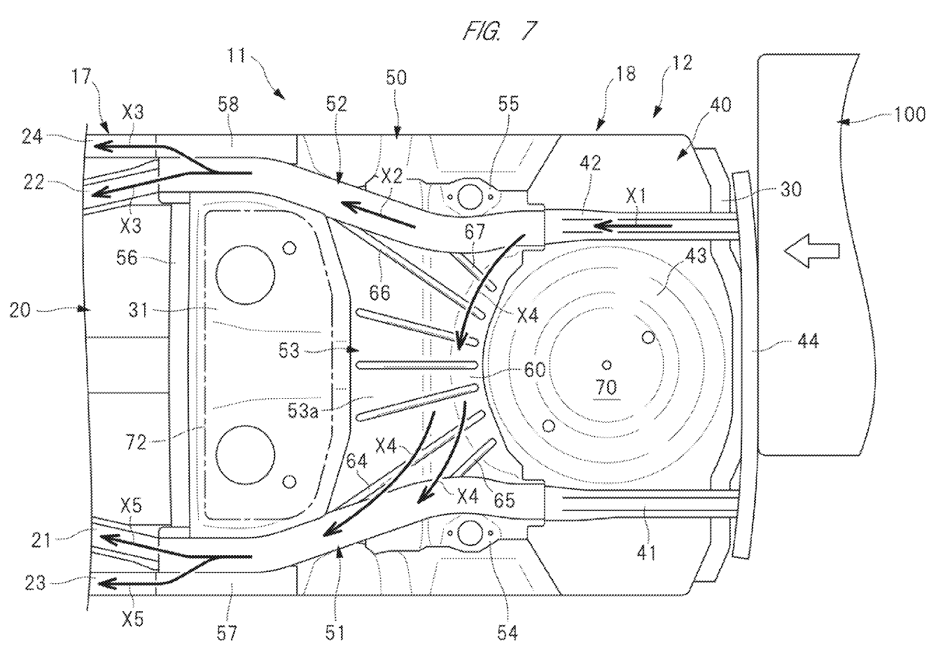

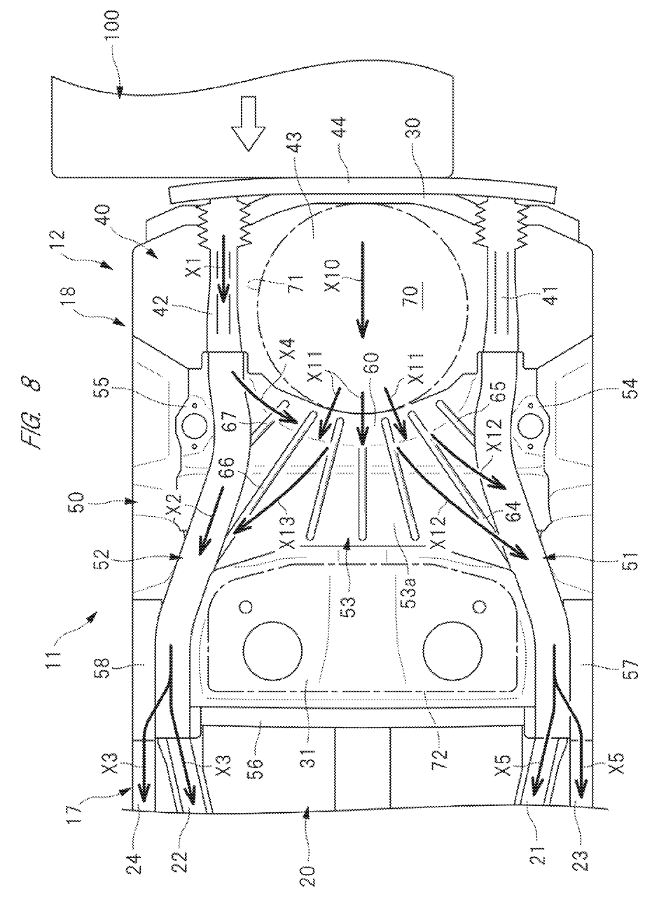

As described above, the die-cast structure 50 comprises the curved wall 60 and the ribs 64 to 67. This allows collision load to be distributed to the first frame 51 and the second frame 52 even if a rear-end collision such as one caused by another vehicle occurs, making it possible to suppress deformation of the die-cast structure 50, that is, deformation of the rear floor 18. FIGS. 7 and 8 are diagrams each illustrating an example of the collision load being transmitted during a rear-end collision.

As illustrated in FIG. 7, when another vehicle 100 makes an offset rear-end collision with the vehicle 11, the collision load is primarily applied from the rear bumper beam 44 to the left-rear side member 42 (arrow X1). This collision load is transmitted from the left-rear side member 42 to the second frame 52 (arrow X2), and from the second frame 52 to the left-center side member 22 and the left-side side sill 24 (arrow X3). In addition, since the second frame 52 and the first frame 51 are joined via the floor body 53, the collision load transmitted to the second frame 52 is transmitted to the first frame 51 via the floor body 53 (arrow X4). Further, the collision load transmitted to the first frame 51 is transmitted from the first frame 51 to the right-center side member 21 and the right-side side sill 23 (arrow X5). Note that, since the floor body 53 is provided with the ribs 64 and 65 joined to the first frame 51, the collision load can be efficiently transmitted from the second frame 52 to the first frame 51, as indicated by arrow X4.

Thus, the collision load can be distributed to the first frame 51 and second frame 52 of the die-cast structure 50 even if a large collision load caused by an offset rear-end collision is applied to one of the rear side members 41 and 42, making it possible to suppress deformation of the die-cast structure 50. That is, even if an offset rear-end collision occurs, deformation of the rear floor 18 constituted by the die-cast structure 50 can be suppressed, and thus, a fuel tank 72 disposed in front of the die-cast structure 50 can be protected. Note that this is not limited to offset rear-end collisions. Even during a full-lap rear-end collision, the collision load can be distributed to the first frame 51 and second frame 52, making it possible to suppress deformation of the rear floor 18.

Moreover, the housing 70 constituted by the curved wall 60 and the recess 43 of the rear floor 18 accommodates the spare tire 71. That is, the spare tire 71 is disposed behind the curved wall 60 of the die-cast structure 50. This allows the collision load to be applied to the curved wall 60 via the spare tire 71 and be distributed from the curved wall 60 to both frames 51 and 52, making it possible to suppress deformation of the die-cast structure 50 and of the rear floor 18.

As illustrated in FIG. 8, as the left- and right-rear side members 41 and 42 collapse and deformation of the rear floor panel 40 progresses, the spare tire 71 is pushed toward the front curved wall 60 (arrow X10). That is, when the rear side members 41 and 42 begin to collapse by the rear-end collision, the collision load is applied from the rear bumper beam 44 to the curved wall 60 via the spare tire 71 (arrow X11). Subsequently, the collision load is transmitted from the curved wall 60 of the floor body 53 to both the first frame 51 and the second frame 52 (arrows X12, X13). Note that, since the floor body 53 is provided with the ribs 64 and 65 joined to the first frame 51, the collision load can be efficiently transmitted from the curved wall 60 toward the first frame 51, as indicated by arrow X12. In addition, since the floor body 53 is provided with the ribs 66 and 67 joined to the second frame 52, the collision load can be efficiently transmitted from the curved wall 60 to the second frame 52, as indicated by arrow X13.

Thus, when the rear side members 41 and 42 begin to collapse by the rear-end collision, the collision load can be applied from the spare tire 71 to the curved wall 60 and can be distributed from the curved wall 60 to the frames 51 and 52. This makes it possible to suppress deformation of the die-cast structure 50, and thus, the fuel tank 72 disposed in front of the die-cast structure 50 can be protected. Note that this is not limited to offset rear-end collisions. Even during a full-lap rear-end collision, the collision load can be distributed from the curved wall 60 to the frames 51 and 52 via the spare tire 71.

### First Modification Example

In the example illustrated in FIG. 5, the die-cast structure 50 is configured such that the ribs 64 and 65 that join the curved wall 60 and the first frame 51 are provided on the lower surface 53a of the floor body 53, and that the ribs 66 and 67 that join the curved wall 60 and the second frame 52 are provided on the lower surface 53a of the floor body 53. However, the structure is not limited to such a configuration. For example, the ribs that join the curved wall 60 and the first frame 51 may be provided not only on the lower surface 53a of the floor body 53 but also on an upper surface 53b of the floor body 53. The ribs that join the curved wall 60 and the second frame 52 may also be provided on the upper surface 53b of the floor body 53.

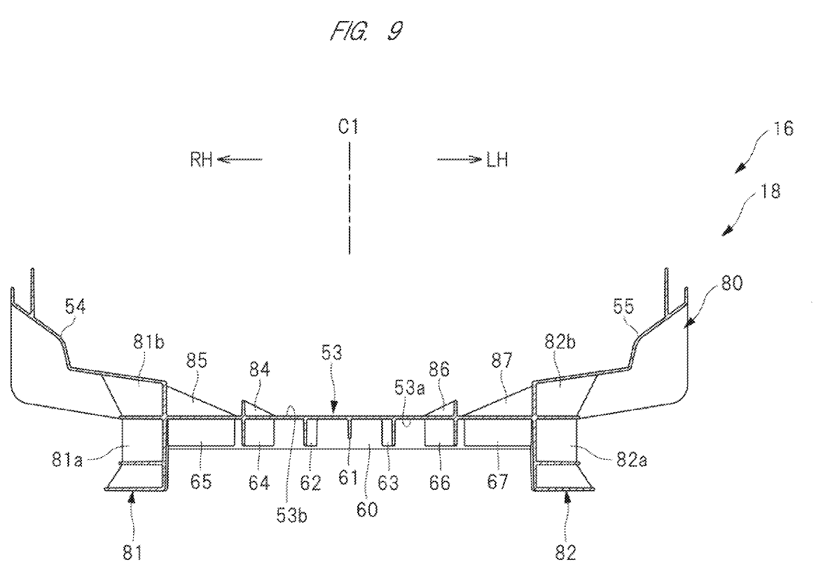

FIG. 9 is a cross-sectional view of another example of the die-cast structure. FIG. 9 illustrates a die-cast structure 80 having the same parts as the die-cast structure 50 illustrated in FIG. 5. In addition, the die-cast structure 80 illustrated in FIG. 9 is a cast part forming the rear floor 18 as in the die-cast structure 50, and is provided between the rear floor panel 40 and the center floor panel 20.

As illustrated in FIG. 9, the die-cast structure 80 comprises a first frame 81 and a second frame 82 each extending in the longitudinal direction of the vehicle body 16. The first frame 81 comprises a frame 81a provided on the lower surface 53a of the floor body 53, and a frame 81b provided on the upper surface 53b of the floor body 53. Similar to the above-described first frame 51, the first frame 81 is joined to the right-rear side member 41 and the right-center side member 21. In addition, the second frame 82 comprises a frame 82a provided on the lower surface 53a of the floor body 53, and a frame 82b provided on the upper surface 53b of the floor body 53. Similar to the above-described the second frame 52, the second frame 82 is joined to the left-rear side member 42 and the left-center side member 22.

The die-cast structure 80 comprises the ribs (first rib) 64 and 65 that join the curved wall 60 and the first frame 81 to the lower surface 53a of the floor body 53, and ribs (first rib) 84 and 85 that join the curved wall 60 and the first frame 81 to the upper surface 53b of the floor body 53. In addition, the die-cast structure 80 comprises the ribs (second rib) 66 and 67 that join the curved wall 60 and the second frame 82 to the lower surface 53a of the floor body 53, and ribs (second rib) 86 and 87 that join the curved wall 60 and the second frame 82 to the upper surface 53b of the floor body 53. In addition, similar to the ribs 64 to 67, the ribs 84 to 87 are inclined relative to the longitudinal direction of the vehicle body 16. Note that the ribs 84 to 87 are joined to an edge of the curved wall 60.

Thus, the die-cast structure 80 is configured such that the ribs 64 to 67 and 84 to 87 are provided on both the lower surface 53a and the upper surface 53b. This allows the collision load to be distributed to the first frame 81 and the second frame 82 of the die-cast structure 80 even if a large collision load caused by an offset rear-end collision is applied to one of the rear side members 41 and 42, making it possible to suppress deformation of the die-cast structure 80. That is, even if an offset rear-end collisions occurs, deformation of the rear floor 18 formed by the die-cast structure 80 can be suppressed, and thus, the fuel tank 72 disposed in front of the die-cast structure 80 can be protected. Note that this is not limited to offset rear-end collisions. Even during a full-lap rear-end collision, the collision load can be distributed to the first frame 81 and the second frame 82, making it possible to suppress deformation of the rear floor 18.

### Second Modification Example

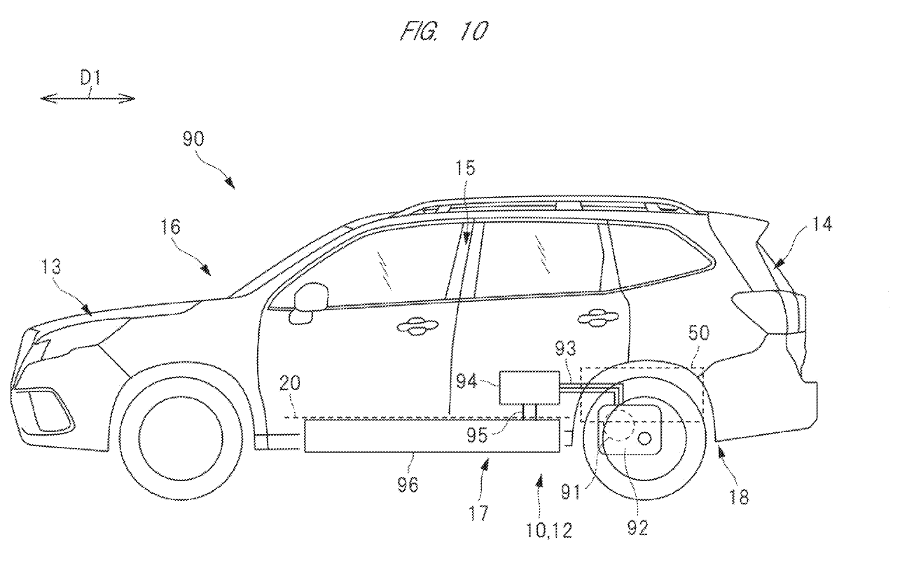

In the illustrated example, the technique of the disclosure is applied to the vehicle 11 comprising the fuel tank 72, but the disclosure is not limited to this. The technique of the disclosure may also be applied to a vehicle 90 comprising a high-voltage battery 96. FIG. 10 is a diagram illustrating another vehicle 90 to which the technique of the disclosure is applied. Note that the vehicle 90 illustrated in FIG. 10 comprises a vehicle body structure similar to the vehicle body structure 10 constituted by the above-described the underbody 12.

As illustrated in FIG. 10, an electric axle 92 comprising an electric motor 91 is disposed below the die-cast structure 50. An inverter 94 is coupled to the electric axle 92 via a high-voltage cable 93, and a high-voltage battery 96 is coupled to the inverter 94 via a power cable 95. In addition, the high-voltage battery 96 is mounted on a lower surface of the center floor panel 20.

Thus, even in the vehicle 90 comprising the high-voltage battery 96, the electric axle 92, and the like, during a rear-end collision, the collision load can be distributed to the first frame 51 and the second frame 52, making it possible to suppress deformation of the die-cast structure 50. This allows deformation of the rear floor 18 to be suppressed, and thus, the electric axle 92 and the high-voltage cable 93 disposed near the die-cast structure 50 as well as the high-voltage battery 96 disposed in front of the die-cast structure 50 can be protected.

### Other Modification Examples

The disclosure is not limited to the above-described embodiments and may be modified in various ways within the range not departing from the gist of the disclosure. In the above description, aluminum alloy is used as the material for the die-cast structure 50, but the disclosure is not limited to this, and magnesium alloy may also be used as the material for the die-cast structure 50. In the illustrated example, the spare tire 71 is accommodated in the housing 70 of the rear floor 18, but the disclosure is not limited to this, and tools such as a jack may also be accommodated in the housing 70 of the rear floor 18. Thus, even when the spare tire 71 is not accommodated in the housing 70 and a rear-end collision occurs, the collision load can be distributed to both frames 51 and 52 as illustrated in FIG. 7, making it possible to suppress deformation of the rear floor 18 formed by the die-cast structure 50.

In the above description, the right-center side member 21 of the center floor panel 20 is used as the right-center frame, and the left-center side member 22 of the center floor panel 20 is used as the left-center frame, but the disclosure is not limited to this. The right-side side sill 23 of the center floor panel 20 may be used as the right-center frame, and the left-side side sill 24 of the center floor panel 20 may be used as the left-center frame. In the illustrated example, the rear floor panel 40 has the substantially circular recess 43, but the shape of the recess 43 is not limited to being substantially circular.

In the example illustrated in FIG. 2, seven ribs 61 to 67 are formed on the die-cast structure 50, but the disclosure is not limited to this, and the number of ribs formed on the die-cast structure 50 may be changed. In addition, the die-cast structure 50 comprises two ribs 64 and 65 that join the curved wall 60 and the first frame 51, but the disclosure is not limited to this, and the die-cast structure 50 may comprise a single rib that joins the curved wall 60 and the first frame 51, or may comprise three or more ribs that join the curved wall 60 and the first frame 51. Similarly, the die-cast structure 50 comprises two ribs 66 and 67 that join the curved wall 60 and the second frame 52, but the disclosure is not limited to this, and the die-cast structure 50 may comprise a single rib that joins the curved wall 60 and the second frame 52, or may comprise three or more ribs that join the curved wall 60 and the second frame 52. Note that a rib that joins the first frame 51 and the second frame 52 in the vehicle width direction may be formed on the die-cast structure 50.

In the above description, the tank floor panel 31 is formed as a sheet metal part, but the disclosure is not limited to this, and a portion corresponding to the tank floor panel 31 may be included in the die-cast structure 50. In addition, in the above description, the center floor panel 20 is formed as a sheet metal part, but the disclosure is not limited to this, and a part corresponding to the center floor panel 20 may be formed by die-casting. Further, a portion corresponding to the center floor panel 20 may be included in the die-cast structure 50.

According to the disclosure, it is possible to suppress deformation of the die-cast structure and the rear floor constituted by the die-cast structure.

1. A vehicle body structure comprising:
a rear floor panel comprising a right-rear frame and a left-rear frame each extending in a longitudinal direction of a vehicle body, and having a recess formed between the right-rear frame and the left-rear frame; and
a die-cast structure joined to the rear floor panel and comprising a first frame joined to the right-rear frame, and a second frame joined to the left-rear frame,
wherein the die-cast structure comprises a curved wall that is continuous with the recess of the rear floor panel, a first rib that joins the curved wall and the first frame, and a second rib that joins the curved wall and the second frame.

2. The vehicle body structure according to claim 1, further comprising a center floor panel joined to the die-cast structure,
wherein the center floor panel comprises a right-center frame joined to the first frame, and a left-center frame joined to the second frame.

3. The vehicle body structure according to claim 1,
wherein the first rib is inclined relative to the longitudinal direction of the vehicle body, and
wherein the second rib is inclined relative to the longitudinal direction of the vehicle body.

4. The vehicle body structure according to claim 1,
wherein the first rib and the second rib are provided on a lower surface of the die-cast structure.

5. The vehicle body structure according to claim 1,
wherein the recess and the curved wall form a housing, and
wherein the housing accommodates a spare tire.
